(19) United States
(12) Patent Application Publication
(10) Pub. No.: US 2008/0010817 A1
(43) Pub. Date: Jan. 17, 2008

(54) HIGH PERFORMANCE NOSEPIECE FOR BLIND BOLT INSTALLATION

(75) Inventor: Cristinel Ovidiu Cobzaru, Murrieta, CA (US)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(73) Assignee: SPS TECHNOLOGIES, LLC, Jenkintown, PA (US)

(21) Appl. No.: 11/760,908

(22) Filed: Jun. 11, 2007

Related U.S. Application Data
(60) Provisional application No. 60/807,202, filed on Jul. 13, 2006.

(51) Int. Cl. B23Q 7/10

(52) U.S. Cl. 29/812.5

(57) ABSTRACT

A nosepiece for use with a riveter for installing a blind bolt. The nosepiece has an active area which is annular and effectively matched to the dimensions of the locking collar of the blind bolt. No tapered surface interferes with the sleeve during installation of the blind bolt. Instead, the active area includes a protrusion which intersects a support surface generally at a ninety degree angle. Providing a minimum or no transition fillet radius from the active area to the support area allows for a minimum length of the active area, providing maximum reinforcement to the active area. It also concentrates the operating stresses in a known area, dispersing them from the critical, working surface of the active area, providing an expected failure mode.

### RELATED APPLICATION (PRIORITY CLAIM)

This application claims the benefit of U.S. Provisional Application Ser. No. 60/807,202, filed Jul. 13, 2006, which is hereby incorporated herein by reference in its entirety.

### BACKGROUND

The present invention generally relates to nosepieces for use with tools for installing blind bolts, and more specifically relates to a high performance nosepiece for use in such an application.

Blind bolts are popular fasteners, for example, in the aircraft industry. They are a good alternative to threaded fasteners, providing comparable joint preloads, with a better ability to resist vibration and the benefit of one side installation. A conventional blind bolt 10 is shown in FIG. 1 and includes a stein 12, a locking collar 14 and a sleeve 16. The stem 12 has a head 18 at one end 20 and a serrated portion 22 proximate an opposite end 24. As shown, the stein 12 extends through the sleeve 16 such that the head 18 of the stem 12 contacts an end 26 of the sleeve 16.

While FIGS. 5-8 relate to the present invention, reference can be made to these Figures with regard to explaining the manner in which a conventional blind bolt is installed. As shown in FIG. 5, to install such a blind bolt, the sleeve 16 of the blind bolt 10 is inserted into an aperture 28 in a workpiece 30 (which consists of two or more structures 30a, 30b), and the jaws 32 of a riveter 40 are used to grip and pull on a serrated stem 12 of the blind bolt. This causes a bulb 42 to form in the blind area 44 of the workpiece 30, as shown in FIG. 6, thereby providing a clamp up load to the workpiece structures 30a, 30b. While the jaws 32 of the riveter 40 pull on the stem 12, an installation load from the riveter 40 to the fastener 10 is transferred to the locking collar 14 of the blind bolt. This installation load is applied to a very small bearing area, which results in extremely high operating stresses. The high stress applied to the locking collar 14 is desirable, and is part of the installation process of the blind bolt 10. During installation, the high stresses developed in the locking collar 14 cause deformation of the locking collar 14 into a groove 46 on the stein, as shown in FIG. 7, which provides vibration resistance. Upon further pulling on the stem 12 by the riveter 40, the stem breaks as shown in FIG. 8 (at the notch 48 shown in FIGS. 5-7), completing the installation of the blind bolt 10.

Due to the locking collar 14, blind bolts such as shown in FIG. 1 are designed for minimal FOD (foreign object debris), a very desirable feature in the aircraft industry, for example. Other blind bolt designs also include a “shift washer” which is integral with the fastener and which provides the correct interface and installation for the locking collar. Upon installation, the shift washer falls. As such, the shift washer only has to withstand the stresses associated with a single installation. However, in the case of installing a blind bolt 10 such as is shown in FIGS. 1 and 5-8, the nosepiece of the riveter 40 has to provide the correct interface, set the locking collar 14 reliably and have a decent life and reliability. Furthermore, the nosepiece has to resist tremendous operating stresses, and retain its shape accurately so it can install correctly all fasteners within its lifespan.

Two nosepiece designs 50, 80 which are currently available in the industry are shown in FIGS. 2 and 3. As shown, both designs provide a long, slender, conical active area 52, 82 to interface with the locking collar 14. The fact that the active areas 52, 82 are conical provides that the active area 52, 82 interferes with an end surface 54 (identified in FIG. 5) of the sleeve 16 of the blind bolt 10. As a result, low nosepiece reliability and life are associated with both of these designs, and these issues are well known. In fact, the industry has tried over the years to eliminate these shortcomings, without success. The most significant improvement was the use of some exotic materials (like Vasco 350). However, the tool life improvement was incremental and reliability did not improve. Additionally, such exotic materials are very expensive and difficult to procure. Furthermore, availability of these types of materials has been decreasing over the past few years

Reliability of the designs shown in FIGS. 2 and 3 is low because at high levels of stress and not enough support of the active area 52, 82, any minor deviation or material, surface or heat treat flaw can cause part failure. As a result, the manufacturing tolerances surfaces and heat treat requirements are very tight, thereby making manufacturing very costly and causing high rejection rates.

Furthermore, the life of one of the nosepieces 50, 80 shown in FIGS. 2 and 3 can vary from a few installations (i.e., under ten) to a few hundred installations, and virtually identical nosepieces can have very different life expectancies, making the product very unreliable.

Finally, the designs shown in FIGS. 2 and 3 provide inconsistent and poor dimensional stability; they can also have several forms of failure that become very difficult to detect during operation. Therefore, if the nosepieces are not inspected carefully prior to being re-used, while the nosepiece appears to be in good condition, the dimensional changes may cause faulty fastener installation, a very undesirable outcome.

### OBJECTS AND SUMMARY

An object of an embodiment of the present invention is to provide an improved nosepiece for use with a riveter for installing blind bolts.

Another object of an embodiment of the present invention is to provide a nosepiece which provides a dramatically improved tool life, better reliability and better dimensional stability.

Yet another object of an embodiment of the present invention is to provide a nosepiece which provides a positive visual indication of structural failure.

Briefly, and in accordance with at least one of the foregoing objects, an embodiment of the present invention provides a nosepiece which has an active area which is annular and effectively matched to the dimensions of the locking collar of a blind bolt which the nosepiece is configured to install. The active area is configured to provide that no tapered surface interferes with the sleeve during installation of the blind bolt. Instead, the active area includes a protrusion which intersects a support area at a ninety degree angle. The transition from the protrusion to the support area surface may provide a fillet. Providing a minimum or no transition fillet radius from the active area to the support area allows for a minimum length of the active area, providing maximum reinforcement to the active area. It also concentrates the operating stresses this area, dispersing them from the critical, working surface of the active area, providing an expected failure mode. In other words, by providing a minimum or no transition fillet radius from the active area to the support area, the operating stresses are concentrated in this area. As such, when there is structure failure, such failure tends to occur at this location, causing the part to chip, thereby providing a positive, very easy visual indication of the working condition of the nosepiece. Preferably, an external surface of the nosepiece is threaded such that the nosepiece can be threaded into a riveter. Also, preferably a rear surface of the nosepiece is tapered and is configured to engage and spread open the jaws of a riveter, such that the stern of a blind bolt can be readily inserted into the riveter through a bore in the nosepiece, without the jaws interfering.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 illustrates a conventional blind bolt;

FIGS. 2 and 3 illustrate prior art nosepiece designs;

FIG. 4 illustrates a nosepiece which is in accordance with an embodiment of the present invention; and

FIGS. 5-8 provide a sequence of cross-sectional views, showing the nosepiece of FIG. 4 being used in association with a riveter to install a blind bolt such as is shown in FIG. 1.

### DESCRIPTION

While the present invention may be susceptible to embodiment in different forms, there is shown in the drawings, and herein will be described in detail, an embodiment thereof with the understanding that the present description is to be considered an exemplification of the principles of the invention and is not intended to limit the invention to that as illustrated and described herein.

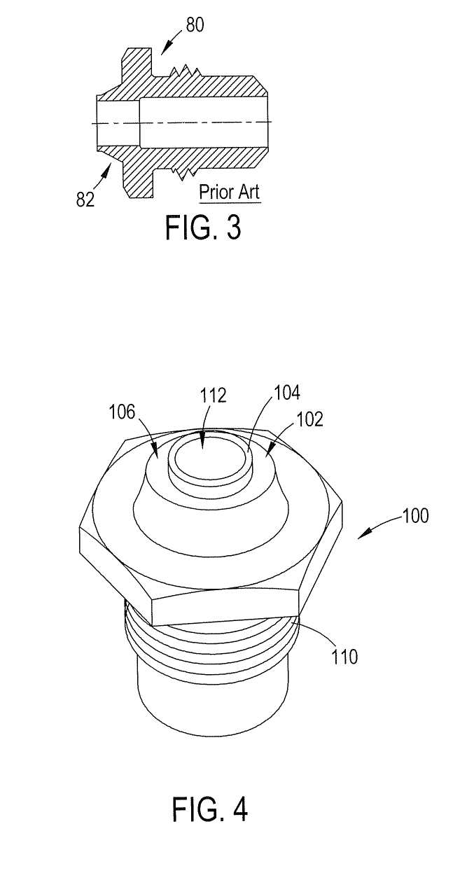

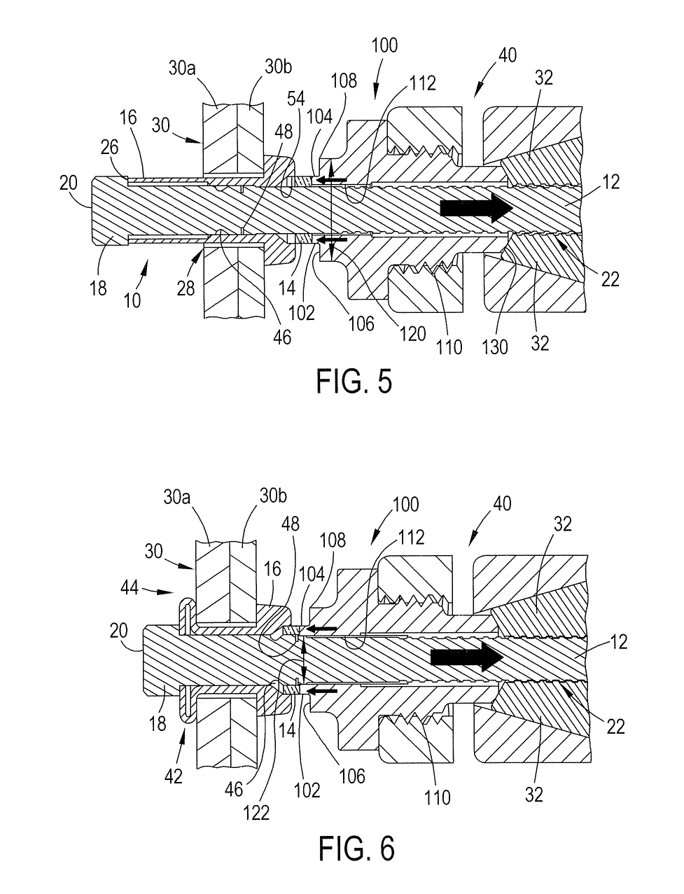

FIG. 4 illustrates a nosepiece 100 which is in accordance with an embodiment of the present invention. As shown, the nosepiece 100 has an active area 102 which includes an annular protrusion 104. The protrusion 104 is effectively matched to the dimensions of the locking collar 14 of a blind bolt 10 which the nosepiece 100 is configured to install. The active area 102 is configured to provide that, unlike the designs shown in FIGS. 2 and 3, no tapered surface interferes with surface 54 of the sleeve 16 of the blind bolt 10 during installation. Instead, the active area 104 includes a protrusion 102 which intersects a support area 106 at generally a ninety degree angle. The transition from the protrusion 102 to the intersecting, support area 106 may provide a fillet, and the support area 106 has an outer edge 108 which may also be rounded. An external surface 110 of the nosepiece 100 is threaded such that the nosepiece 100 can be threaded into a riveter 40, and more specifically into a pulling head which is engaged with a riveter 40. Specifically, the nosepiece 100 can be engaged with, for example, the following pulling heads: H955 pulling head, H9055 pulling head or a right angle pulling head such as the H866-3, 4, 5 or 6 pulling head, each of which is commercially available from Textron Fastening Systems, the assignee of the present invention. Also, the following riveters, for example, can be used: the G746a power riveter, the G747 power riveter, the G704B riveter, the G30 hand riveter or the G750 Å hand riveter, each of which is commercially available from Textron Fastening Systems, the assignee of the present invention. The riveter, pulling head and nosepiece can be used to install, for example, Cherrylock® A Code fasteners, which are also commercially available from Textron Fastening Systems, the assignee of the present invention.

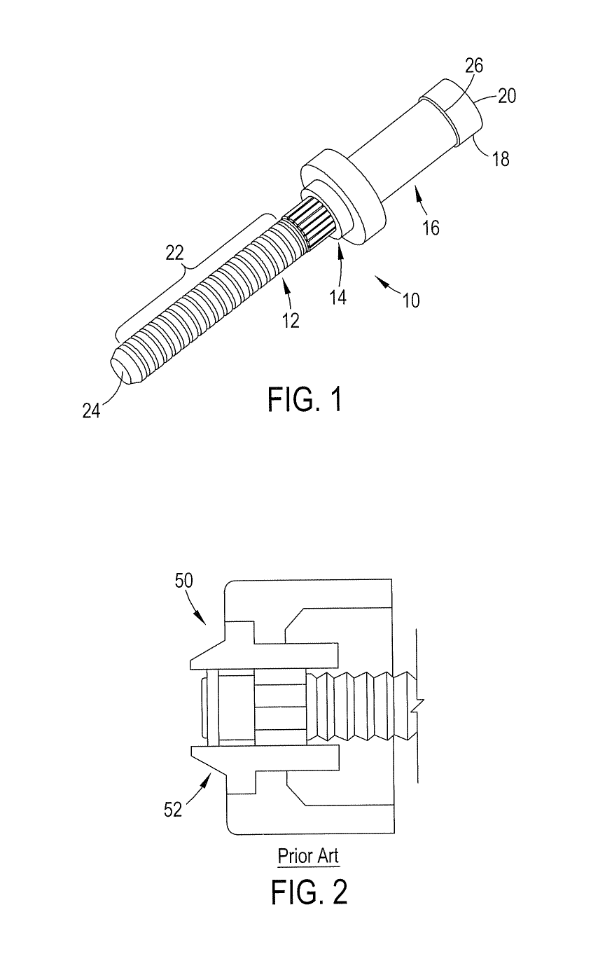

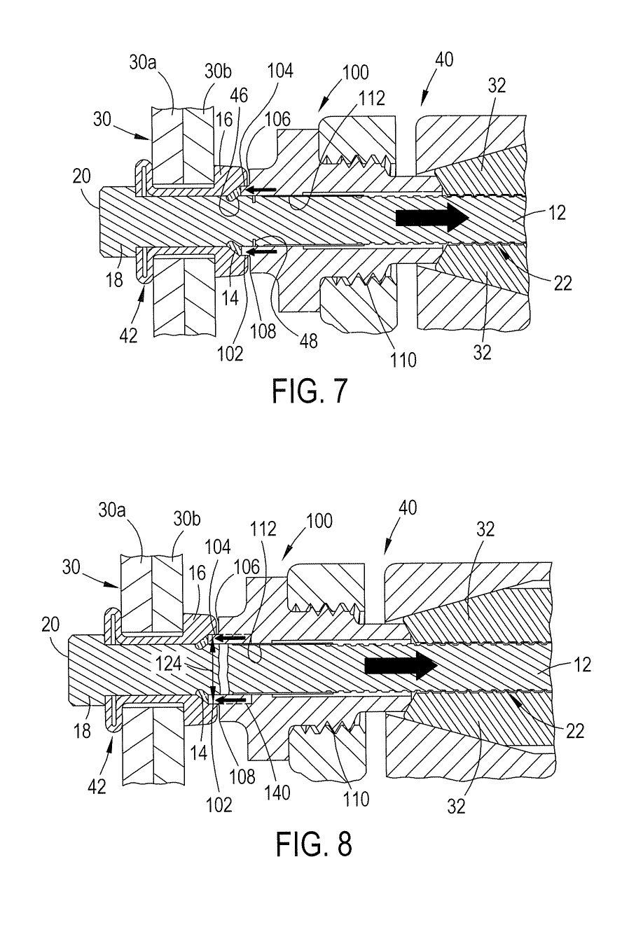

FIGS. 5-8 provide a sequence of cross-sectional views, showing the nosepiece 100 of FIG. 4 being used in association with a riveter 40 to install a blind bolt 100 such as is shown in FIG. 1. As shown, the nosepiece 100 has a throughbore 112 for receiving a stem 12 of the blind bolt 10, and the surface 106 which intersects with the annular protrusion 102 has an outside diameter (dimension 120 in FIG. 5) which is larger than both the inside diameter (dimension 122 in FIG. 6) and outside diameter (dimension 124 in FIG. 8) of the protrusion 102. Also, as shown in FIG. 5, preferably a rear surface 130 of the nosepiece 100 is tapered and is configured to engage and spread open the jaws 32 of the riveter 40, such that the stein 12 of the blind bolt 10 can be readily inserted into the riveter 40, through the bore 112 in the nosepiece 100, without the jaws 32 interfering.

To install the blind bolt 10, the sleeve 16 of the blind bolt 10 is inserted into an aperture 28 in a workpiece 30, as shown in FIG. 5, and the stem 12 of the fastener 10 is inserted into the nosepiece 100, such that the annular protrusion 102 contacts the locking collar 14 of the fastener 10. Then the riveter 40 is actuated, causing the jaws 32 of the riveter 40 to grip and pull on the serrated stern 12 of the blind bolt 10. This causes a bulb 42 to form in the blind area 44 of the workpiece 30, as shown in FIG. 6, thereby providing a clamp up load to the workpiece structures 30a, 30b. While the jaws 32 of the riveter 40 pull on the stem 32, an installation load from the riveter 40 to the fastener is transferred by the nosepiece 100 to the locking collar 14 of the blind bolt 10. This installation load is applied to a very small bearing area, which results in extremely high operating stresses. The high stress applied to the locking collar 14 is desirable, and is part of the installation process of the blind bolt 10. During installation, the high stresses developed in the locking collar 14 cause deformation of the locking collar 14 into a groove 46 on the stern 12, as shown in FIG. 7, which provides vibration resistance. Upon further pulling on the stein 12 by the riveter 40, the stem 12 breaks as shown in FIG. 8, completing the installation of the blind bolt 10.

As shown in FIGS. 5-8, the active area 104 is annular, short and stubby, with a minimum fillet radius at the transition to the support area 106. Since the fillet radius would interfere with the setting of the locking collar to the full depth, this portion has to be compensated by increasing the length of the protrusion 102 (i.e., the extent to which the protrusion 104 extends from the support area 106). By keeping this to a minimum, the feature is as stubby as necessary. The dimensions of the protrusion 102 (i.e, the inside diameter (dimension 122 in FIG. 5) and the outside diameter (dimension 124 in FIG. 8) closely match the fastener dimensions, providing maximum bearing surface for the active area. The protrusion length (i.e., the extent to which the protrusion 104 extends from the support area 106) of the annular active area 104 closely matches the maximum standard requirement for setting the locking collar 14. As such, during installation, the fastener 100 is precisely guided and centered during installation and by keeping corner breaks of the work surface to an absolute minimum.

Providing a minimum or no transition fillet radius from the active area 104 to the support area 106 allows for a minimum length of the active area, providing maximum reinforcement to the active area. It also concentrates the operating stresses in this area, dispersing them from the critical, working surface of the active area, providing an expected failure mode. In other words, by providing a minimum or no transition fillet radius from the active area 104 to the support area 106, the operating stresses are concentrated in this area. As such, when there is structure failure, such failure tends to occur at this location, causing the part to chip, thereby providing a positive, very easy visual indication of the working condition of the nosepiece.

The short, stubby design provides excellent support to the stress area, keeping the active area rigid. Buckling and radial plastic deformation of the annular area are not possible. The only failure mode allowed by the current design is compressive (axial), and that can be controlled very well by the mechanical properties of the material used.

The nosepiece area 106 behind the active annular feature 104 is quite sizeable by comparison, able to absorb considerable shock and provide the much needed hoop (radial) strength. Corner breaks at the outside diameter/inside diameter of the annular active area are minimal, to keep the load bearing area as large as possible.

Preferably, the nosepiece 100 is made out a material which has the following qualities: very high strength (to resist the repeated high compressive stresses); good toughness (to resist the high shock loads); easily machinable; readily available; and low cost. Some exotic materials could meet some of the mechanical criteria and a different embodiment of this design could be manufactured out of those types of materials (i.e., Maraging 350). However, material availability and cost are critical for this competitive market.

The material proven to meet all the desired characteristics is a common ultrahigh strength alloy steel (4140/41L40), processed by austempering to its maximum mechanical capabilities. The austempering process improves the material toughness with no adverse effect on its desired strength.

The nosepiece 100 shown in FIGS. 4-8 provides dramatically improved tool life (such as 600 to 1200 installations), good reliability (in extensive tests, all nosepieces such as is shown in FIGS. 4-8 had similar life expectancy, within reasonable margins) and dimensional stability (the design is very rigid, with very little or no dimensional changes being possible over the life of the nosepiece).

Furthermore, the nosepiece 100 shown in FIGS. 4-8 is configured to provide a positive visual indication of structural failure. This is because, in operation, the stress is concentrated in a known area, away from the working surface, and that is precisely where failure occurs. When that happens, the material in the stressed area chips away, providing an excellent visual indication of the failure. By comparison, the designs 50, 80 illustrated in FIGS. 2 and 3 do not behave consistently, progressively deforming over the life of the nosepiece. As such, if the nosepieces are not inspected carefully prior to being re-used, and a nosepiece has suffered dimensional changes, there could be faulty fastener installation.

In an alternative embodiment, the annular area 104 can be a separate component made out of a different material and to higher precision requirements, pressed or otherwise mounted into the body of the nosepiece. This option is represented by the dotted line 140 in FIG. 8).

While embodiments of the present invention are shown and described, it is envisioned that those skilled in the art may devise various modifications of the present invention without departing from the spirit and scope of the disclosure.

What is claimed is:

1. A nosepiece which is configured to engage a riveter and engage a locking collar of a blind bolt, said nosepiece comprising: a protrusion which is configured to engage the locking collar of the blind bolt; and a support area, wherein said protrusion intersects the support area at a ninety degree angle.

2. A nosepiece as recited in claim 1, wherein a fillet is disposed at a point at which the protrusion intersects the support area.

3. A nosepiece as recited in claim 1, wherein said protrusion and said support area define an active area of the nosepiece, wherein said active area is configured to provide that no tapered surface interferes with a sleeve of the blind bolt during installation of the blind bolt.

4. A nosepiece as recited in claim 1, wherein a fillet is disposed at a point at which the protrusion intersects the support area, and wherein said protrusion and said support area define an active area of the nosepiece, wherein said active area is configured to provide that no tapered surface interferes with a sleeve of the blind bolt during installation of the blind bolt.

5. A nosepiece as recited in claim 1, wherein an external surface of the nosepiece is threaded such that the nosepiece is threadable into the riveter.

6. A nosepiece as recited in claim 1, wherein a rear surface of the nosepiece is tapered and is configured to engage and spread open jaws of the riveter, such that a stern of the blind bolt is readily insertable into the riveter through a bore in the nosepiece, without the jaws interfering.

7. A nosepiece as recited in claim 1, wherein an external surface of the nosepiece is threaded such that the nosepiece is threadable into the riveter, and wherein a rear surface of the nosepiece is tapered and is configured to engage and spread open jaws of the riveter, such that a stem of the blind bolt is readily insertable into the riveter through a bore in the nosepiece, without the jaws interfering.

8. A nosepiece as recited in claim 1, wherein said nosepiece comprises a body and the protrusion is a separate component than the body and is mounted on the body.
